(19) United States
(12) Patent Application Publication
(10) Pub. No.: US 2017/0105431 A1
(43) Pub. Date: Apr. 20, 2017

(54) 2 Sisters Sweet Potato Salad

(71) Applicant: Carolyn Hollis, Mattapan, MA (US)

(72) Inventor: Carolyn Hollis, Mattapan, MA (US)

(21) Appl. No.: 14/884,059

(22) Filed: Oct. 15, 2015

(51) Int. Cl. A23L 1/216; A23L 1/223; A23L 1/225; A23L 1/221; A23L 1/32; A23L 1/212

(52) U.S. Cl. CPC A23L 1/216; A23L 1/32; A23L 1/2123; A23L 1/225; A23L 1/221; A23L 1/223; A23V 2002/00

(57) ABSTRACT

This invention relates to a recipe and a method of making homemade potato salad made of boiled potatoes; boiled eggs; stalks of celery; pickle relish; Yellow mustard; sweet pepper relish; Hellman's mayonnaise; and black pepper.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to the field of recipes for making salad. The invention, particularly relates to a recipe of homemade potato salad, the composition and method for preparing the same.

(2) Background of the Invention

Traditionally, preparing homemade potato salad is a labor of love for home-style cooking. Dicing, measuring, mixing and creating the entire recipe from scratch is very time consuming. Trial and error often plays a role in making a meal of flavorful delight. Too much of any one ingredient can overpower and ruin the flavor of the potato salad. Too little of any one ingredient can lead to a bland potato salad taste. Cooks do not want to be remembered for an ill tasting potato salad. With all the work that is involved in preparing the potato salad the cook would like the potato salad to be appreciated when it is eaten by the family or guests.

A number of innovative salads have been provided in the prior art. Even though these innovations may be suitable for the specific individual purposes to which they address, however, they differ from the embodiments of present invention in that they do not provide a health-enhancing tasty ethnic salad.

Prior art U.S. patent application Ser. No. 11/590,462 to Regina Y. Green, describes about key ingredients of the present invention may be suitable for the specific individual purposes to which they address, however, they differ in the manner as the referenced application do not disclose the information regarding the processing of the ingredients.

Another Prior art U.S. patent application Ser. No. 13/864,155 to Alice Chang, talks about the presence of boiled potatoes and mayonnaise but the optimum conditions for boiling the potatoes to get the best nutritional value are not disclosed in this prior art.

The prior arts mentioned above do not provide a homemade healthy food option in today's rigorous life style. The present invention provides an option of healthy food which has high nutritional value and low fattening ingredients.

### SUMMARY OF THE INVENTION

In the view of the foregoing disadvantages inherent in the known types of homemade salads now present in the prior art, the present invention provides an improved homemade potato salad. As such, the general purpose of the present invention, which will be described subsequently in greater detail, is to provide a new and improved recipe for preparing homemade potato salad which has all the advantages of the prior art and none of the disadvantages.

An object of the invention is to provide a recipe for homemade potato salad.

It is another object of the present invention to provide a homemade salad that is high in nutritional value and great taste.

It is another object of the present invention to provide a composition of matter for use in producing high-fiber, low-calorie and low fat salad.

It is another object of the present invention to provide a dietary fiber gel that provides high nutritional value to potato salad.

It is another object of the present invention to provide a combination of different vegetables and edible preprocessed products.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

In a first aspect the present invention provides an easy to make potato salad for one of being used by itself. The potato salad according to the current invention comprises mayonnaise present in an amount of 1 and ½ cups. Pickle relish and sweet pepper relish is present in the discussed potato salad in an amount of about half cup and 11 oz bottle respectively. Yellow Mustard, black pepper are present in amount of 2 tablespoon and a quarter tablespoon respectively and 8 Yukon gold white potatoes.

It should be noted that all of the above ingredients are commercially available at local supermarkets. Items such as mayonnaise are marketed by Hellman's among others. The other items are also all available from various manufactures. In a more preferred embodiment of the invention such mayonnaise the current discussed potato salad is added in an amount of 1 and ½ cups (preferably Hellman's) and wherein the pickle relish is present in an amount of one half cup(½).

In the more preferred embodiment yellow mustard and black pepper are added in quantity of 2 tbsp. and ¼ tbsp. The potato salad according to another preferred embodiment also contain sweet pepper relish and chopped celery in the quantity of 11 oz and 3 stalks respectively. In another preferred embodiments of the invention the method of making the potato salad according to the current invention.

Method:

The process of making the potato salad according to the current invention includes

FIRST STEP: boiling 8 Yukon gold white potatoes with a tablespoon of salt, until tender. Immediately cooling the potatoes under cold water to stop them from over cooking. The potatoes thus obtained after boiling should be a little firm and cool or cold.

SECOND STEP: Thereafter mix thoroughly 6 boiled eggs (nicely cut up) with 3 stalks of celery chopped fine, ½ cup of pickle relish , 2 Tbsp of yellow mustard, 11 oz jar of sweet pepper relish, 1 and ½ cups of Hellmans mayonnaise and ¼ tea spoon of black pepper.

In the LAST STEP: mix the potatoes obtained after boiling and cooling (cut into medium) with the mixture as obtained in step 2.

The potato salad thus obtained will have unique taste of both sweet and tart which is appreciated by all who consume the “2 sisters sweet potato salad”.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A homemade potato salad comprising of ingredients:
potatoes;
at least one boiled egg;
at least one of stalk of celery;
pickle relish;
yellow mustard;
sweet pepper relish;
Hellman's mayonnaise; and,
black pepper.

2. The homemade potato salad according to claim 1, wherein said plurality of potatoes are selected from the group consisting of Russet potato, Yukon gold potatoes, Red potatoes, White potatoes, Yellow potatoes, Purple or Blue potatoes, Fingering potatoes and Petite potatoes.

3. The homemade potato salad according to claim 1, wherein the ratio of potatoes and said at least one egg is in the rage of 4:3.

4. The homemade potato salad according to claim 1, wherein said yellow mustard is taken in concentration 0.4% with respect to said potatoes.

5. The homemade potato salad according to claim 1, wherein said stalk of celery is in concentration of 0.2% with respect to said egg.

6. The homemade potato salad according to claim 1, wherein the concentration of the Hellman's mayonnaise and black pepper is as per taste of a consumer.

7. The method for preparing the homemade potato salad comprising steps of:
a) cleaning and rinsing potatoes with fresh water;
b) finely chopping potatoes;
c) boiling potatoes in lightly salted water;
d) cooking until potatoes turn tender;
e) boiling eggs in lightly salted water;
f) rinsing boiled potatoes and boiled eggs under cold water;
g) peeling shell off the boiled eggs;
h) finely chopping boiled eggs;
i) mixing finely chopped eggs with stalks of finely chopped celery, pickle relish, yellow mustard, sweet pepper relish, Hellman's mayonnaise and black pepper; and
j) adding finely chopped potatoes to mixture of step (i).
